(19) United States
(12) Patent Application Publication
(10) Pub. No.: US 2006/0111006 A1
(43) Pub. Date: May 25, 2006

(54) Layered elastomeric fabric and process for making

(76) Inventors: Dimitri Zafiroglu, Wilmingon, DE (US); Debora Massouda, Wilmingon, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/204,447

(22) Filed: Aug. 16, 2005

Related U.S. Application Data
(60) Provisional application No. 60/601,833.
(60) Provisional application No. 60/615,996, filed on Oct. 5, 2004.

(51) Int. Cl. D04H 1/00; D04H 3/00; B32B 5/26; D04H 1/54

(52) U.S. Cl. 442/382; 442/352; 442/381; 442/383; 442/409; 442/335

(57) ABSTRACT

Provided is a process comprising contacting a spun-bonded polypropylene fabric with a layer of fibers that are not polypropylene, point-bonding the layers together to form a bonded layered fabric, exposing the bonded layered fabric to heat under suitable conditions followed by cooling to form a layered elastomeric fabric, the bonded layered fabric being disposed in a manner to permit free-shrinkage in at least one dimension to occur during at least a portion of the heating, and wherein the point-bonds in the bonded layered fabric comprise 5-60% of the total fabric area. A layered elastomeric fabric produced by the process and textile products made of the layered elastomeric fabric are also provided.

### FIELD OF INVENTION

The present invention is directed to the field of stretch fabrics, and specifically to layered elastomeric fabrics characterized by a high degree of crimping and high elastic strength wherein the highly elastic member is a spun-bonded polypropylene fabric. The invention is further directed to a process for preparing the layered fabric.

### BACKGROUND OF THE INVENTION

Numerous layered fabrics comprising a layer of polypropylene fibers in woven or non-woven fabric are known in the art. JP1996176947A 1996-7-9 to OJI PAPER CO., LTD., discloses a non-woven laminate created from spun-bonded nonwovens. Two layers of continuous filaments each of a different polymer are formed into a web with a bonding layer between them. The two polymers are chosen to have different levels of shrinkage so that in a separate heat treatment step, bulk is developed. Polypropylene (PP) can be one of the filaments.

Bersted et al. (U.S. Pat. No. 5,945,215) discloses a polypropylene fiber non-woven suitable for carpet backing, the non-woven being prepared from textured heat-set polypropylene fibers.

It is known in the art to subject-oriented polypropylene (PP) fibers to elevated temperatures in order to achieve what is variously known as a “hard elastic”, “high stretch-high recovery”, or “springy” fiber. As discussed in Polypropylene Fibers: Science and Technology, M. Ahmed, PP. 412 ff, Elsevier Scientific Publishing Company (1982), these fibers have distinctive properties. In one aspect they are characterized by stacked crystalline lamellae wherein the lamellae surfaces are normal to the fiber axis—the to be “row-nucleated morphology.” The “hard elastic fibers” therein described are characterized by recovery of the 80% from a 25% extension. They are also characterized by initial tensile modulus on the order of 2,800 MPa. This initial tensile modulus is orders of magnitude higher than that of well-known elastic fibers in wide commercial use in textiles such as Lycra®.

The preparation of “hard elastic”polypropylene is described in Herrman (U.S. Pat. No. 3,256,258). Disclosed therein are fibers having gamma orientation of 10° to 30°, as determined by X-ray diffraction, which fibers are produced in a melt-spinning operation, subject to spin-stretching, preferably without a post-draw step, to produce a fiber having orientation of 10 to 50°, followed in turn by heating to a temperature of 105° C. to 160° C. (preferably 130° C. to 140° C.), for a duration of 0.6 seconds to 24 hours, the time being unimportant so long as the result is the hard elastic fiber. Herrman suggests that fabrics could be made therefrom but provides no teaching therefore.

For a fabric to have application in textiles it needs to have acceptable visual and tactile aesthetics, and, in the case of “stretch” fabrics, provide a high degree of stretchability with rapid recovery and little set. The hard elastic fibers of Herrman (U.S. Pat. No. 3,256,258) form a web, which is more “plastic” than “textile” in aesthetics because the fibers have no textile-like bulk or softness.

Furthermore, the hard elastic fibers of Herrman are characterized by very high elastic or Young's modulus. When a fabric having sufficient cover for textile applications is prepared therefrom, the modulus is so high that for typical apparel uses it effectively does not perform like a stretch fabric at all because it requires too much force to stretch it. A much lower basis weight fabric will have limited application because of insufficient cover and flimsiness.

Preparation of spun-bonded PP fabrics is a known art, and is described in Ahmed, op.cit., pp. 443 ff.

Hassenboehler et al. (U.S. Pat. No. 5,244,482) discloses inelastic nonwovens of PP fibers heated to below their melting point and stretched in the machine direction to create nonwovens with a high degree of CD recoverable stretch. Heating and stretching is accomplished by passing the nonwoven into an oven and withdrawing it at a higher velocity. Velocity ratios range from 1.1:1 to 2:1. Resulting webs recover at least 70% from a 50% elongation in the cross direction.

Mormon (U.S. Pat. No. 4,965,122) discloses a “reversibly necked” elastic material attained by, among other materials, a multilayer structure comprising a spun-bonded PP fabric, the structure being subject to stretching, heating, and cooling in order to make the desired stretch product of the invention.

### SUMMARY OF THE INVENTION

The present invention provides for a layered elastomeric fabric comprising a first layer consisting essentially of a spun-bonded fabric of uncrimped polypropylene fibers exhibiting the properties characteristic of hard elastic polypropylene, and a second layer consisting essentially of crimped fibers that are not polypropylene, the fibers of the first layer being mutually interbonded with the fibers of the second layer.

The present invention further provides for a process comprising contacting a spun-bonded polypropylene fabric with a layer of fibers that are not polypropylene, point-bonding the layers together to form a bonded layered fabric, exposing the bonded layered fabric to a temperature of 150° C. to 170° C. over a period of 30 seconds to 300 seconds followed by cooling to form a layered elastomeric fabric, the bonded layered fabric being disposed in a manner to permit free-shrinkage in at least one dimension to occur during at least a portion of the heating, and wherein the point-bonds in the bonded layered fabric comprise 5-60% of the total fabric area.

The present invention further provides for a textile product comprising a layered elastomeric fabric comprising a first layer consisting essentially of a spun-bonded fabric of uncrimped polypropylene fibers exhibiting the properties characteristic of hard elastic polypropylene, and a second layer consisting essentially of crimped fibers that are not polypropylene, the fibers of the first layer being mutually interbonded with the fibers of the second layer.

### BRIEF DESCRIPTION OF THE FIGURES

FIG. 1 is a photomicrograph depicting a cross-section of the layered elastomeric fabric of the invention showing the flat first layer consisting essentially of a spun-bonded fabric of uncrimped polypropylene fibers characterized by the hard elastic morphology and a crimped second layer consisting essentially of fibers that are not polypropylene.

### DETAILED DESCRIPTION

The present invention is directed to a layered elastomeric fabric characterized by textile-like aesthetics. The fabric is elastic and has high stretch recovery.

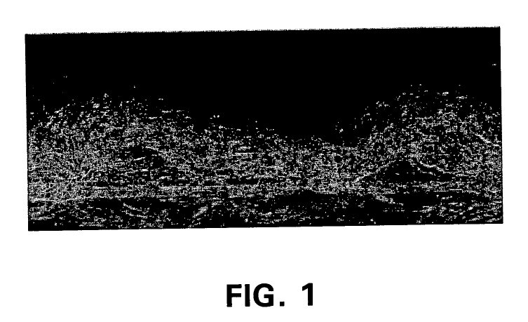

The present invention provides a novel “stretch fabric” highly suitable for use in textiles, employing a low basis weight, hard elastic PP spun-bonded fabric layer to provide the desired stretch-recovery properties and a second layer comprising crimped fibers to provide the desired textile-like aesthetics such as bulk, softness, and cover. This may be seen in FIG. 1, which shows a cross section of a fabric of the invention. The flat, hard elastic spun-bonded polypropylene fabric is indicated in FIG. 1 by the horizontal line running through the middle of the structure. The crimped fibers on either side of the spun-bonded polypropylene fabric show considerable bulk.

The present invention is limited to the use of isotactic polypropylene fibers. The practitioner hereof shall understand that the recitation herein of “polypropylene” shall mean in every instance isotactic polypropylene unless specifically stated to be otherwise.

The spun-bonded polypropylene layer of the layered elastomeric fabric of the present invention is characterized by fibers that are randomly oriented in a sheet structure which fibers form an integrated sheet by virtue of being bonded to one another at some, but not at all, cross-over points. This is referred to in the art of non-wovens as “point-bonding”. Suitable for the practice of the process of the present invention are spun-bonded polypropylene fabrics having basis weight in the range of 3 g/mm² to 16 g/mm². The higher the basis weight of the fabrics employed, the higher the effective modulus of the resulting fabric of the invention will be. Thus, choice of basis weight will be determined by the needs of the particular application.

The point-bonds are characterized by 1) the average area of individual point-bonds, and 2) the percentage of the total area of the fabric occupied by point-bonds. Thus, it is possible to have a given percentage of the total area of the fabric made up of relatively many point-bonds of small area or relatively few point-bonds of larger area.

The polypropylene fibers in the spun-bonded layer of the layered elastomeric fabric of the invention are typically, though not necessarily, of circular or near-circular cross-section, of a diameter of 1 to 100 micrometers, preferably from 10 to 30 micrometers. While there is no particular limitation on the size of point-bonds, the largest dimension of the point-bonds in typical practice hereof are in the range of 10 to 1000 micrometers, with 100 to 500 micrometers preferred. According to the present invention, the total area of point-bonded areas shall be in the range of 5%-60% of the total fabric area, preferably 20% to 40%. If the point-bonded areas exceed about 60% of the total area of the layered elastomeric fabric, the fabric begins to exhibit qualities more characteristic of a plastic film than of a textile. If the point-bonded areas represent less than the 5% of the total area of the fabric, the fabric exhibits insufficient strength for most practical applications.

The layered elastomeric fabric of the invention consists essentially of a layer comprising crimped fibers that are not polypropylene, and an uncrimped or flat layer consisting essentially of hard elastic polypropylene. The layered elastomeric fabric of the invention achieves its desirable combination of properties by virtue of the mixed fiber morphology thereof. The desired degree of cover, and visual and tactile aesthetics for textile applications is achieved by virtue of the large portion of crimped fibers therein. The elastic properties are achieved because an applied load is borne only by the uncrimped hard elastic spun-bonded polyproprylene fabric layer, which is of sufficiently low basis weight to enable expansion of the fabric up to 30% by application of forces typical for a given textile application. For example, a cocktail dress will require different stretch recovery response than will athletic shorts. Fabrics having a basis weight in the range of 3 g/mm² to 16 g/mm² suitable for the practice of the present invention are known in the art as “scrims.” So long as the degree of extension is lower than that at which the crimp is pulled out of a significant number of the crimped fibers, the applied tensile load is borne only by the low basis weight spun-bonded hard elastic polypropylene layer. As a result, the layered elastomeric fabric of the invention may be made to exhibit the stretch and recovery properties of a variety of commercially available “stretch fabrics” such as spandex or rubberized textile goods by selection of the appropriate weight of the spun-bonded PP scrim layer.

The first layer of the layered elastomeric fabric of the invention must be point-bonded to the second layer of the layered elastomeric fabric of the invention, as must any layers additional to the first and second. This may be beneficially accomplished by any means known in the art, including thermal welding, chemical adhesive bonding, and mechanical means such as needling, air or water jet entanglement and the like. It is found in the practice of the invention that mechanically needled or needle-punched fabrics with a needle spacing in the range of 150 to 500 dpi is quite satisfactory.

In the spun-bonded fabric suitable for the process of the invention are point-bonds ranging in area from about 0.03 mm² to about 3 mm². Point-bonds that are too large give the resulting fabric an inhomogeneous appearance and texture. Point-bonds that are too small provide insufficient integrity to the fabric. It is found in the practice of the invention that point-bonds of 0.75 mm² are satisfactory. The total area occupied by the point-bonds should not exceed about 60% of the total area thereof.

In the process of the invention is prepared a layered elastomeric fabric comprising a first layer consisting essentially of a spun-bonded fabric of uncrimped isotactic polypropylene fibers characterized by the hard elastic morphology and a second layer consisting essentially of crimped fibers that are not polypropylene.

The process of the invention comprises 1) contacting a spun-bonded polypropylene fabric with a layer of fibers that is not polypropylene, 2) point-bonding the layers together to form a bonded layered fabric, 3) exposing the bonded layered fabric to a temperature of 150° C. to 170° C. over a period of 30 seconds to 300 seconds followed by cooling, the bonded layered fabric being disposed in a manner to permit free-shrinkage in at least one dimension to occur during at least a portion of the heating, wherein the point-bonds in the bonded layered fabric comprise 5-60% of the total fabric area.

In the process of the invention, the spun-bonded PP fabric will undergo shrinkage of 5 to 40% on an areal basis to form a scrim of hard elastic PP fibers. The fibers that are not PP in the layer that is bonded to the spun-bonded polypropylene (PP) layer are selected so that they undergo little or no degradation or substantial shrinkage. As a result, upon shrinkage of the PP layer, the fibers adhered thereto will become crimped.

Spun-bonded PP fabrics suitable for use in the process of the invention are known in the art, and are described in Ahmed, op.cift. pp. 443 ff. In accord with Ahmed, op.cit., for the purposes of the present invention the term “spun-bonded polypropylene” shall be taken to refer to a fabric formed from one or more continuous filaments prepared by extrusion or solution spinning of isotactic polypropylene laid down in a random or quasi-random path or pattern with numerous overlaps forming cross-over points but substantially free of entanglements, and wherein at a portion of the cross-over points the filaments converging thereat are bonded together by so-called point-bonds. Suitable for the practice of the invention are point-bonds ranging in area from about 0.03 mm to about3 mm². It is found in the practice of the invention that point-bonds of about 0.75 mm² are satisfactory. The total area occupied by the point-bonds in the spun-bonded polypropylene fabric suitable for the process of the invention should not exceed about 60% of the total area of the fabric.

The second layer may be in any convenient form for purposes of the particular use. It may be woven, knit, non-woven, paper, or other fibrous goods. Further, the second layer need not constitute a sheet or fabric of any kind, but may be in the form of individual fibers, fibrids, or floc. Preferably, the second layer comprises a carded web of staple fibers.

The fibers of the second layer may be any that are desired for the particular application with the proviso that they must exhibit neither significant thermal degradation nor significant true shrinkage. “True shrinkage” refers to an actual reduction in the fiber length, end to end, rather than, for example crimping wherein the fiber may exhibit a helical or saw-toothed configuration but little or no actual reduction in path length end to end. By contrast the PP fibers in the bonded layered fabric undergo “true” shrinkage, thereby forming the hard elastic morphology.

Fibers suitable for use in the second layer of the layered elastomeric fabric of the invention include but are not limited to staple fibers of polyesters such as polyethylene terephthalate, polyaramids such as poly(para-phenylene terephthalamide) and poly (meta-phenyleneterephthalamide, and wood pulp.

In accord with the process of the invention, the bonded layered fabric is subject to heating in a relaxed state in order to facilitate the formation of the hard elastic morphology in the spun-bonded PP fabric layer. This is beneficially accomplished by over-feeding the bonded layered fabric to a shrinkage zone wherein it is subject to heating and undergoes the desired degree of shrinkage. For the purposes of this invention over-feeding shall be understood to encompass both continuous over-feeding into a continuous device such as a tenter frame, and also placing a piece of fabric into a frame or other holder such that the dimensions of the fabric exceed that of the frame within which it is held. In any event, the fabric is held in a tension-free configuration (save for the effect of gravity) as it is introduced into the shrinkage zone.

While the preferred embodiment of the process of the invention calls for the layered elastomeric fabric to be heated without constraint to fully realize the hard elastic state of the spun-bonded PP moiety, one of skill in the art will appreciate that subjecting the layered elastomeric fabric to constraint in at least one dimension for at least some portion of the heating period can be achieved simply by adjusting the amount of overfeeding into the shrinkage zone, and that the resulting fabric will exhibit therefrom somewhat modified properties of modulus, crimp, and elastic recovery.

It should be noted that the specific oven temperature at which the desired effect on a given fabric will be achieved will depend both upon the specific make-up of the fabric—the number of layers, and the make-up of each layer—and the specific design of the oven. Each oven and heating method has a heat transfer coefficient associated with it. It is expected that, with a modest amount of experimentation, the desired operating region can be determined for a specific heating apparatus and fabric.

In one embodiment of the invention, the spun-bonded fabric suitable for the process of the invention is disposed such that it is under tension in one planar dimension but unconstrained in the orthogonal planar dimension prior to heating. In such embodiment, elasticity results only in the unconstrained dimension.

In another embodiment of the process of the invention, the spun-bonded fabric suitable for the process of the invention is disposed in such manner that at the conclusion of the shrinkage accompanying the heating step, the thus treated fabric (now the layered elastomeric fabric of the invention) is under tension.

The spun-bonded fabric suitable for the process of the invention need not be held in any particular manner prior to heating so long as the desired degree of constraint—or lack thereof—is achieved. It has been found advantageous in the conduct of the specific experiments described herein below to provide a frame for mounting each test specimen. In the embodiment hereof wherein the spun-bonded fabric suitable for the process of the invention remains tension free throughout the heating and shrinkage process, a fabric sample larger than the frame in both planar dimensions is therein mounted by attaching with clips or pins. A sufficient excess must be employed to ensure that the fabric remains tension-free throughout. This may be readily determined by ordinary experimentation on the particular fabric of interest.

Another method, more suitable for continuous production processes is to overfeed (in both the machine direction and transverse direction) roll-stock of the spun-bonded fabric suitable for the process of the invention into a tenter frame and to sustain the speed and separation of the two rows of pins such that the desired degree of constraint—or lack thereof—is maintained.

In yet another method, the spun-bonded fabric suitable for the process of the invention is fed to a simultaneous continuous biaxial stretching machine comprising individually driven pin arrays or clips so that the degree of overfeed in both the MD and TD can be continuously adjusted.

Heating may be accomplished by any convenient means known in the art. It has been found advantageous to employ an oven pre-heated to a predetermined temperature in the range of 150° C. to 170° C. In the process of the invention, the spun-bonded fabric suitable for the process of the invention is disposed in the manner desired concerning constraint, introduced into a preheated air oven, and allowed to undergo heating for a period of 30 seconds to 300 seconds, preferably 30 seconds to 120 seconds.

It is found in the process of the present invention that rapid heating is desirable for achieving optimum properties. Thus, it is preferred to maintain the oven at a temperature at the high end of the range and to expose the specimen for a shorter duration.

The successful execution of the process of the invention to produce the layered elastomeric fabric of the invention requires that the spun-bonded fabric suitable for the process of the invention undergo substantially uniform shrinkage consistent with the type of imposed constraint thereupon. It is as a result of the shrinkage of the PP fibers in the first, spun-bonded fabric layer that the fibers in the second layer undergo crimping.

One of skill in the art will appreciate that the properties of the layered elastomeric fabric prepared according to the process of the invention will depend upon the properties of the individual layers such as the basis weight of the fabrics, the degree of shrinkage in the spun-bonded PP layer, the stiffness of the fibers in the second layer or other layers, and so forth. It is further found in the practice of the invention that respective orientations in the two layers may also affect properties. This effect may be beneficially employed to prepare laminates with improved balance of properties.

It is found in the practice of the invention that commercially prepared spun-bonded polypropylene fabrics typically exhibit higher modulus in the machine direction than in the cross-direction because the fibers exhibit higher orientation in the machine direction. However, when the second layer is prepared in such manner that there is a preferred orientation in the fabric itself, and the layering according to the process of the present invention is performed by crossing the two orientation directions so that they are at right angles to each other, the resulting layered elastomeric fabric of the invention exhibits an improved balance of properties such as tensile modulus over what would be expected based upon shrinkage of the unlayered spun-bonded PP fabric. It is observed that the actual orientation of the fibers in the spun-bonded fabric has been changed as a result of the influence of the fibers in the second layer.

One of skill in the art will appreciate that numerous such additives as are typically combined with fabrics may be incorporated into the layered elastomeric fabric hereof. Such additives include photochemical stabilizers such as UV absorbents, flame-retardants, coatings, finishes, and the like.

In a further embodiment of the present invention, the layered elastomeric fabric hereof is employed in textile goods. There is no limitation on the types of textile goods in which the layered elastomeric fabric hereof can be employed, but it is contemplated that it will be preferentially employed in apparel and home furnishings rather than industrial uses. For example, contemplated within the scope of the present invention are consisting of disposable apparel such as laboratory cover-alls including clean room suits, surgical gowns, surgical drapes, gloves, glove liners, thermal underwear, shell fabrics for jackets and coats, blankets and bedding, upholstery fabrics, and mattress ticking. The fabric of the present invention may be used in any application wherein the combination of ready stretchability and high recovery combined with soft “hand” textile-like appearance, and good cover are desired.

The textile goods contemplated in the present invention may be fabricated by ordinary means known in the art such as cutting and sewing, including both laser cutting and scissor cutting, and seamless construction, thermal seaming, and the like. All such methods are known in the art. Conventional dyeing and finishing operations may also be employed consistent with the fiber content of the second layer of the layered elastomeric fabric hereof, provided that the conditions of dyeing and finishing are not disruptive to the integrity of the layered structure or to the hard elastic crystalline morphology of the PP fibers.

Applicants specifically incorporate the entire content of all cited references in this disclosure. Where a range of numerical values is recited herein, unless otherwise stated, the range is intended to include the endpoints thereof, and all integers and fractions within the range. It is not intended that the scope of the invention be limited to the specific values recited when defining a range.

The invention is further described in the specific embodiments hereinbelow.

### EXAMPLES

In the following Examples, the bonded layered fabric of the desired dimensions was cut and mounted in a frame, affixed thereto with pins, clips, or similar articles. The thus-mounted fabric was placed into a model 1330 F circulating air convection oven (VWR), retrofitted with two (2) digital display Cal model 3300 controllers (one for process control and one for overtemperature protection).

The interior dimensions of the oven chamber were 16½″ deep×13⅛″ wide×14¾″ high. Hooks to hang a framed sample extended 1½″ down from top so that a framed sample was positioned 6⅜″ from the hot air inlet. A thermocouple was positioned 2¾″ from the top and 4″ from the right oven wall. The thermocouple was connected to a Doric 412A digital readout with a precision of 0.1° C.

The framed sample was hung in the oven with the long axis vertical, and oriented perpendicular to the airflow 2¾″ from the top, and 2¼from the bottom. The “bottom” was two (2) perforated metal shelves totaling 1⅞″ thick laid on the oven bottom for all trials.

The prepared sample was rapidly inserted into the preheated oven by mounting on the overhead hook. The oven door was closed and a timer was started for the desired heating time. When the timer went off, the temperature of the thermocouple was noted, and the sample quickly removed.

The fabric in Examples 1-4 and Comparative Examples 1-8 was prepared as follows: A card web was prepared by combining of 80% T94S polyester staple fibers and 20% T254 bi-component polyester binder fiber, cross-lapped and needled together at 150 ppi to form an integrated web. The resulting carded web was then itself needled into Elite 05 spun-bonded polypropylene at 500 PPI. The carded web was on top and needling was effected from the top down. Average weight after needling was 2.7 oz/yd².

The conditions of feeding and heat treatment and the results are shown in Table 1. In Table 1 “Degree of Overfeed” refers to the amount of overfeed, the first number referring to the machine direction, the second to the crossdirection. The % Set and % Recovery are calculated from the following formulae

$$\% set = 100 \times \frac{\begin{matrix}( recovered length after stretching ) - \\ ( original length before stretching )\end{matrix}}{( original length before stretching )}$$

$$\% recovery = 100 \times \frac{\begin{matrix}( stretched length ) - \\ ( recovered length after stretching )\end{matrix}}{\begin{matrix}( stretched length ) - \\ ( original length before stretching )\end{matrix}}$$

Each data point was obtained in the following manner: After heat treatment, a test strip was cut and mounted in an Instron testing machine. The strip was stretched in the indicated direction to 25% strain, and then allowed to relax fully for several seconds. This procedure was repeated twice, and then the degree of set and recovery were determined. When the Example number is preceded by the designation “CE” it means that it is a comparative Example—not of the present invention.

TABLE 1
Results of Heating and Tensile Cycling

| | | | | | | | Load at |
|---|---|---|---|---|---|---|---|
| | Degree of | Oven | | | | | 25% |
| | Overfeed | Temperature | Exposure Time | Direction of | | % | Elongation |
| Example # | (%) | (° C.) | (min) | Stretch | % Set | Recovery | (lb/in) |
| CE1 | 0 | 175 | 1 | MD | 4.8 | 50 | 6.7 |
| CE2 | 0 | 175 | 1 | XD | 6.3 | 48 | 3.6 |
| 1 | 40/30 | 173 | 1 | MD | 4.6 | 52 | 3.9 |
| 2 | 40/30 | 173 | 1 | XD | 5.0 | 52 | 3.1 |
| CE3 | 20/20 | 161-162 | 5 | MD | 6.6 | 52 | 4.8 |
| CE4 | 20/20 | 161-162 | 5 | XD | 9.5 | 47 | 2.5 |
| CE5 | NA | NONE | NA | MD | 11.3 | 54 | 2.3 |
| CE6 | NA | NONE | NA | XD | 13.0 | 47 | 0.8 |
| CE7 | 20/20 | 180 | 1 | MD | 4.6 | 53 | 6.2 |
| CE8 | 20/20 | 180 | 1 | XD | 8.8 | 53 | 2.9 |
| 3 | 20/20 | 160 | Tenter Frame | MD | 4.3 | 53 | 3.7 |
| 4 | 20/20 | 160 | Tenter Frame | XD | 5.4 | 52 | 3.5 |

What is claimed is:

1. A layered elastomeric fabric comprising 1) a first layer consisting essentially of a spun-bonded fabric of uncrimped polypropylene fibers exhibiting the properties characteristic of hard elastic polypropylene, and 2) a second layer consisting essentially of crimped fibers that are not polypropylene, the fibers of the first layer being mutually interbonded with the fibers of the second layer.

2. A process comprising 1) contacting a spun-bonded polypropylene fabric with a layer of fibers that are not polypropylene, 2) point-bonding the layers together to form a bonded layered fabric, 3) exposing the bonded layered fabric to a temperature of 150° C. to 170° C. over a period of 30 seconds to 300 seconds followed by cooling to form a layered elastomeric fabric, the bonded layered fabric being disposed in a manner to permit free-shrinkage in at least one dimension to occur during at least a portion of the heating, and wherein the point-bonds in the bonded layered fabric comprise 5-60% of the total fabric area.

3. The process of claim 2 wherein the basis weight of the spun-bonded polypropylene fabric is in the range of 3 g/mm² to 16 g/mm².

4. The process of claim 2 wherein the polypropylene fibers are characterized by an approximately circular cross-section with a diameter of 1 to 100 micrometers.

5. The process of claim 2 wherein the bonding of the layers is effected by needle punching.

6. The process of claim 2 wherein the second layer is a carded web of staple fibers.

7. The process of claim 2 wherein the layered fabric is constrained in one dimension during heating.

8. The process of claim 2 wherein the heating is accomplished in a tenter frame.

9. A textile product comprising 1) a layered elastomeric fabric comprising a first layer consisting essentially of a spun-bonded fabric of uncrimped polypropylene fibers exhibiting the properties characteristic of hard elastic polypropylene and 2) a second layer consisting essentially of crimped fibers that are not polypropylene, the fibers of the first layer being mutually interbonded with the fibers of the second layer.

10. The textile product of claim 9 further comprising point-bonds the total area of which is in the range of 5-60% of the total fabric area.

11. The textile product of claim 9 wherein the point-bonds range in size from about 0.03 mm² to about 3 mm².

12. The textile product of claim 9 wherein the polypropylene fibers are characterized by an approximately circular cross-section of a diameter of 1 to 100 micrometers.

13. The textile product of claim 9 in the form of a product selected from the group consisting of disposable apparel such as laboratory cover-alls including clean room suits, surgical gowns, surgical drapes, gloves, glove liners, thermal underwear, shell fabrics for jackets and coats, blankets and bedding, upholstery fabrics, and mattress ticking.

14. A layered elastomeric fabric produced by the process of claim 9.
